(19) United States
(12) Patent Application Publication
(10) Pub. No.: US 2015/0336010 A1
(43) Pub. Date: Nov. 26, 2015

(54) SYSTEM AND METHOD FOR CONDUCTING AN INTERACTIVE SCAVENGER HUNT

(71) Applicant: Urs Wiederkehr, Irvine, CA (US)

(72) Inventor: Urs Wiederkehr, Irvine, CA (US)

(21) Appl. No.: 14/282,948

(22) Filed: May 20, 2014

(51) Int. Cl. A63F 13/85; A63F 13/63

(52) U.S. Cl. CPC A63F 13/85; A63F 13/63

(57) ABSTRACT

A systems and methods for conducting an interactive scavenger hunt are disclosed employing a mobile device with a mobile device app download, providing an adventure kit, creating and installing one or more custom signs, posts and interactive devices in various locations remote of each other, sending an activation code and directions to a participant via the mobile device app, and providing one or more clues to the participant based on one of the mobile device app and the one or more custom signs, posts and interactive devices.

### INCORPORATION BY REFERENCE

Applicant(s) hereby incorporate herein by reference any and all patents and published patent applications cited or referred to in this application.

### TECHNICAL FIELD

This disclosure relates to to scavenger hunts, and more particularly to interactive, technology-enabled scavenger hunts.

### BACKGROUND

Generally, a scavenger hunt is a game in which the organizers prepare a list defining specific items, which the participants—individuals or teams—are to seek to gather. Such games likely originated or evolved from ancient folk games and came into particular popularity in the 1930's in New York City. The hunt is typically a race, wherein the individual or team that is first to gather all the “items” and return to a specified location is the winner.

Such games have evolved from actually locating and bringing back physical objects to simply “capturing” the object, location, event, activity, etc. in either still or video photography to now often being played completely on-line or incorporating Internet-based technology such as might run through a smartphone app. Some such scavenger hunts are simply a list of “items” to “gather,” while in other variations each item found contains a clue that then leads to the next item, such that players don't know anything beyond the current item they are seeking, relying on it to somehow lead them to the next one, and so on. As used throughout this Application, the term “scavenger hunt” is to be taken in its broadest sense to mean any game involving an individual or team moving, physically or virtually, from one object, location, event, activity, or the like to another, whether based on a list or clues provided along the way.

Smartphone-based scavenger hunts, specifically, are presently known in a few forms. The SpotDash™ mobile app, at one time available at spotdash.com or spotdash.cbslocal.com, is a smartphone-based “mix of city guide, quiz game and scavenger hunt that gives [a player] an insider's view of a city . . . . SpotDash allows [a player] to answer location-based challenges as [they] take unique “adventures,” exploring [a] city while earning badges and competing to win great prizes.”

Huntzz, available at huntzz.com, is “a smartphone app with real-world treasure (scavenger) hunts and tour guides in one that also allows any individual, location, organisation or events company to create and share their own hunt anywhere in the world.”

With the Traverse Traveler™ scavenger hunt, described at traversetraveler.com/autism, “teams navigate from place to place, using the Traverse Traveler smartphone app (available for iPhone & Android) to “check in” at each location, complete tasks and collect prize tickets along the way . . . . Instructions for each activity and clues to the next location are supplied by the app.”

Wondrground, available at 148apps.com/news/wondrground-takes-scavenger-hunt, is a “location based scavenger hunt app that lets [a participant] go on missions and explore certain cities [and] create [their] own missions to share with friends, decode clues, [and] unlock secrets throughout [cities such as] New York City, La., Boston and Chicago.” Wondrground advertises that it enables users to “Create [their] own missions anywhere and share with [their] friends,” “Decode clues to discover hidden knowledge,” “Unlock secrets and unusual fun facts about the major cities using object recognition technology (seeing through your phone),” and “Earn points and achievements for completing and creating missions.”

The Go Game is an iPhone scavenger hunt app that is location or event specific and employs the app to provide clues, riddles, or challenges within a customized mission that result in points being scored and advancement to subsequent stages until the mission is completed (see venturebeat.com/2011/03/10/the-go-game-iphone).

The prior art described above teaches various scavenger hunts even based on mobile phone apps, but does not teach a system and method for conducting an interactive scavenger hunt that comprises, among other unique features, creating and installing one or more custom signs, posts and interactive devices in various locations remote of each other, sending an activation code and directions to a participant via the mobile device app, and providing one or more clues to the participant based on one of the mobile device app and the one or more custom signs, posts and interactive devices. Solutions have been long sought but prior developments have not taught or suggested any complete solutions, and solutions to these problems have long eluded those skilled in the art. Thus there remains a considerable need for devices and methods able to overcome these limitations.

### SUMMARY

Contemplated embodiments of the interactive scavenger hunt system can provide certain benefits in construction and use which give rise to the exemplary advantages described below.

Embodiments of the present invention solve the problems described above by providing a new and novel system and method for conducting an interactive scavenger hunt. There is provided, in the exemplary embodiment, a system and method for conducting an interactive scavenger hunt employing at least one mobile device, comprising creating and making available a mobile device app for download to the at least one mobile device, creating and installing one or more custom signs, posts and interactive devices in various locations remote of each other, sending an activation code and directions to a participant via the mobile device app, and providing one or more clues to the participant based on one of the mobile device app and the one or more custom signs, posts and interactive devices.

A primary objective inherent in the embodiment of the above described system and method of use is to provide advantages not taught by the prior art.

Other features and advantages of aspects of the present invention will become apparent from the following more detailed description, taken in conjunction with the accompanying drawings, which illustrate, by way of example, the principles of aspects of the invention.

Further contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The interactive scavenger hunt system is illustrated in the figures of the accompanying drawings which are meant to be exemplary and not limiting, and in which:

FIG. 1 is a block diagram of an exemplary system for conducting an interactive scavenger hunt, in accordance with at least one embodiment.

FIG. 2 is a flow chart representative of an exemplary method of use thereof, in accordance with at least one embodiment.

FIG. 3 is a partial exploded perspective view of an exemplary component thereof, in accordance with at least one embodiment.

FIG. 4A is a perspective view of a further exemplary component thereof, in accordance with at least one embodiment.

FIG. 4B is a perspective view of a still further exemplary component thereof, in accordance with at least one embodiment.

FIG. 5A is a perspective view of a still further exemplary component thereof, in accordance with at least one embodiment.

FIG. 5B is a perspective view of a still further exemplary component thereof, in accordance with at least one embodiment.

FIG. 5C is a perspective view of a still further exemplary component thereof, in accordance with at least one embodiment.

FIGS. 5D-5F are schematic views of screen displays thereof, in accordance with at least one embodiment.

FIG. 5G is a perspective view of a still further exemplary component thereof, in accordance with at least one embodiment.

FIG. 5H is a perspective view of a still further exemplary component thereof, in accordance with at least one embodiment.

FIG. 5I is a perspective view of a still further exemplary component thereof, in accordance with at least one embodiment.

FIG. 6 is a flow chart representative of an alternative exemplary method of use thereof, in accordance with at least one embodiment.

FIG. 7A is a perspective view of a still further exemplary component thereof in a first mode of operation, in accordance with at least one embodiment.

FIG. 7B is a perspective view of the exemplary component of FIG. 7A in a second mode of operation, in accordance with at least one embodiment.

FIG. 8 is a perspective view of a still further exemplary component thereof, in accordance with at least one embodiment.

FIG. 9A is a perspective view of a still further exemplary component thereof in a first mode of operation, in accordance with at least one embodiment.

FIG. 9B is a partial perspective view of the exemplary component of FIG. 9A in a second mode of operation, in accordance with at least one embodiment.

FIG. 9C is a partial perspective view of the exemplary component of FIG. 9A in a third mode of operation, in accordance with at least one embodiment.

FIG. 10A is a partial schematic view of a still further exemplary component thereof in a first mode of operation, in accordance with at least one embodiment.

FIG. 10B is a partial schematic view of the exemplary component of FIG. 10A in a second mode of operation, in accordance with at least one embodiment.

FIG. 10C is a partial schematic view of the exemplary component of FIG. 10A and of a still further exemplary component thereof in a first mode of operation, in accordance with at least one embodiment.

FIG. 10D is a partial schematic view of the exemplary component of FIG. 10C in a second mode of operation, in accordance with at least one embodiment.

FIG. 11A is a perspective view, both in enlarged and reduced scale, of a still further exemplary component thereof, in accordance with at least one embodiment.

FIG. 11B is a perspective view, both in enlarged and reduced scale, of a still further exemplary component thereof, in accordance with at least one embodiment.

FIG. 12 is a flow chart representative of use of an exemplary system and method for conducting an interactive scavenger hunt, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

In the following description, reference is made to the accompanying drawings that form a part hereof, and in which are shown by way of illustration, embodiments in which the interactive scavenger hunt system may be practiced. It is to be understood that other embodiments may be utilized and structural changes may be made without departing from the scope of the interactive scavenger hunt system.

The interactive scavenger hunt system is described in sufficient detail to enable those skilled in the art to make and use the interactive scavenger hunt system and provide numerous specific details to give a thorough understanding of the interactive scavenger hunt system; however, it will be apparent that the interactive scavenger hunt system may be practiced without these specific details.

In order to avoid obscuring the interactive scavenger hunt system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGS.

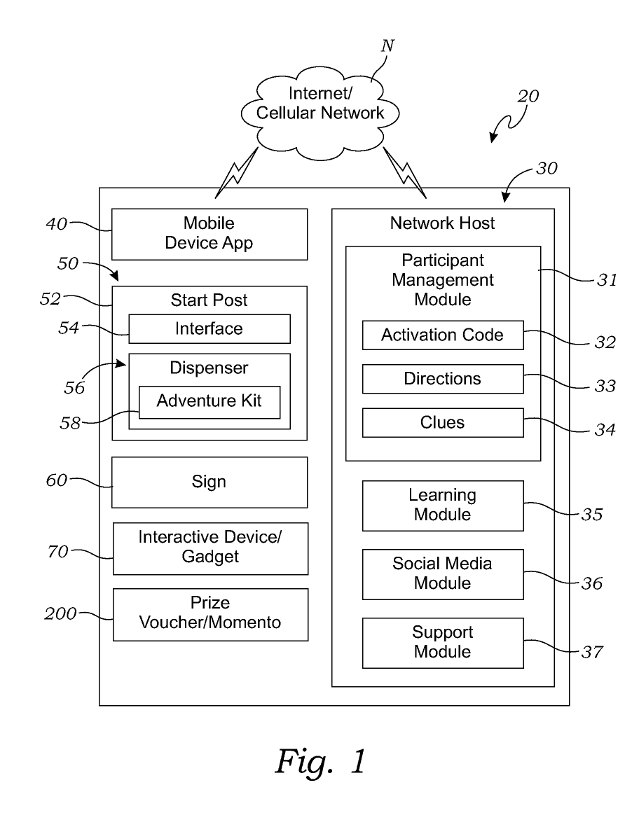

Turning now to FIG. 1, there is shown a block diagram of an exemplary embodiment of an interactive scavenger hunt system 20. The system 20 comprises, in one embodiment, a network host 30 communicating with a mobile device app 40 over the Internet or cellular or other network N.

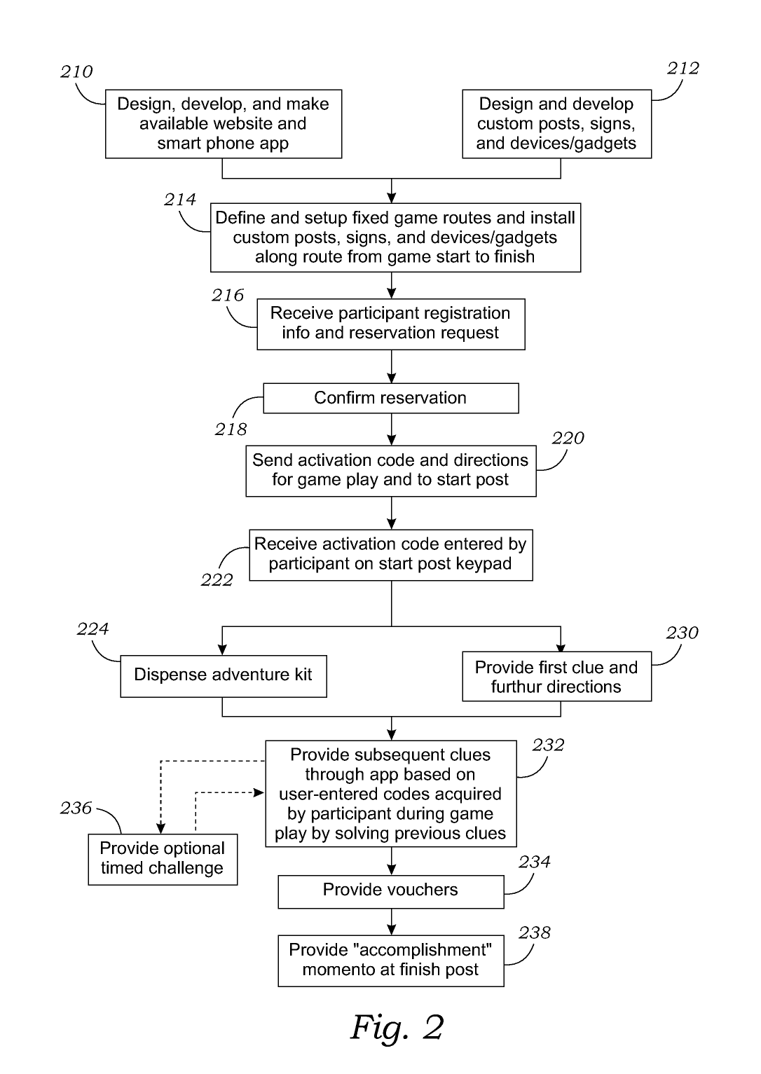

The network host 30 may be computer, server or any other such networked or networkable computing-type device on which may reside software and data and being capable of connecting to and communicating over a network N. Specifically, as shown and will be further appreciated from the below discussion relating to the system 20 in use as depicted in FIG. 2, the network host 30 may supply such data as an activation code 32, directions 33 both for game play and to particular locations, and clues 34 as part of what is collectively referred to as a participant management module 31 of the system and method of conducting an interactive scavenger hunt according to aspects of the present invention.

Such information as sourced in and provided by the participant management module 31 of the network host 30 is thus communicated to a remote device such as a smartphone that has installed and is running the mobile device app 40 configured, among other things, to receive and act on such information from the network host 30 in registering for and/or participating in the scavenger hunt game. In the exemplary embodiment, the network host 30 further includes a learning module 35 configured for providing educational functionality during game play, a social media module 36 configured for pushing and pulling media content during game play, and a support module 37 for support during game play, each of which is described in more detail below.

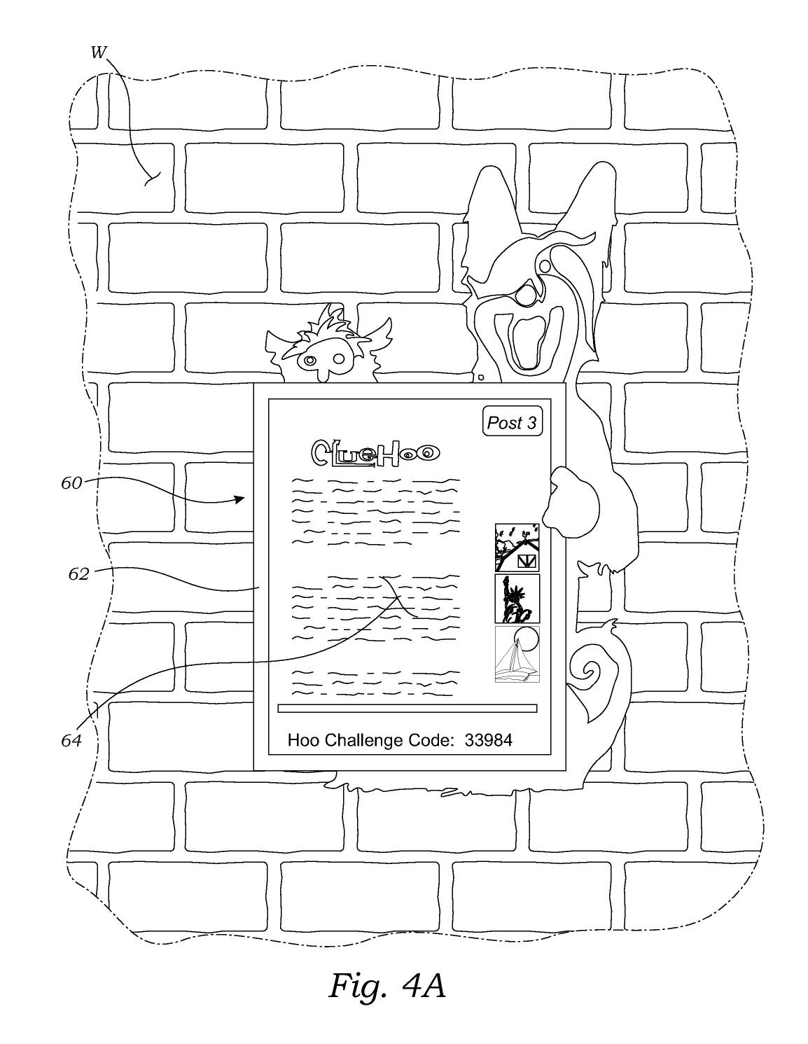

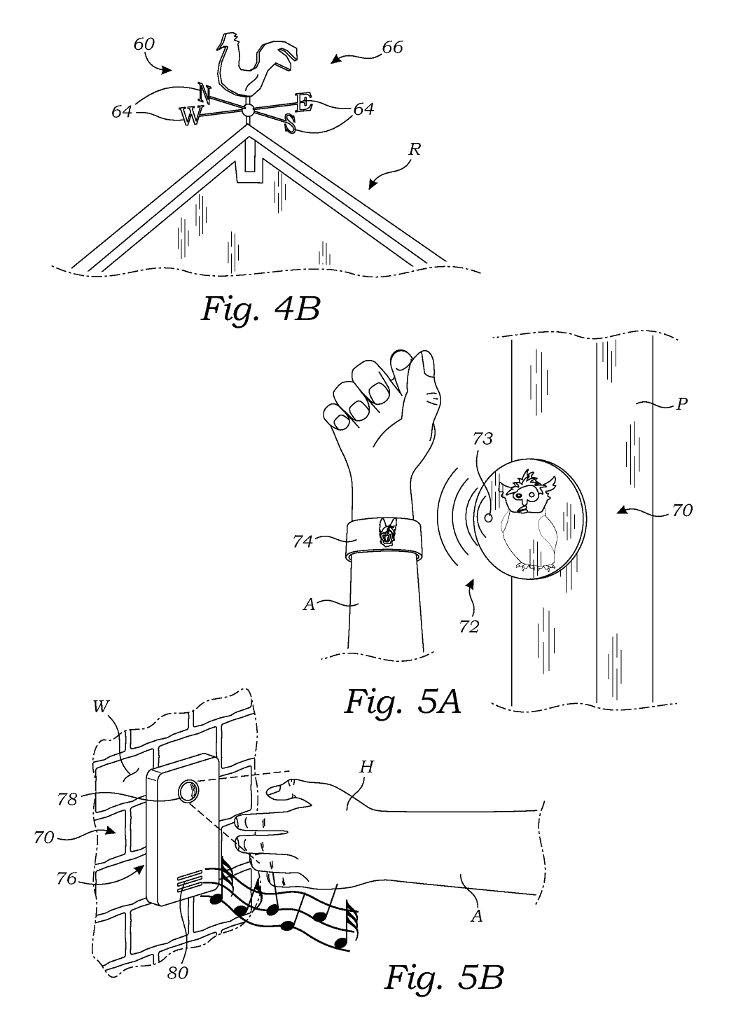

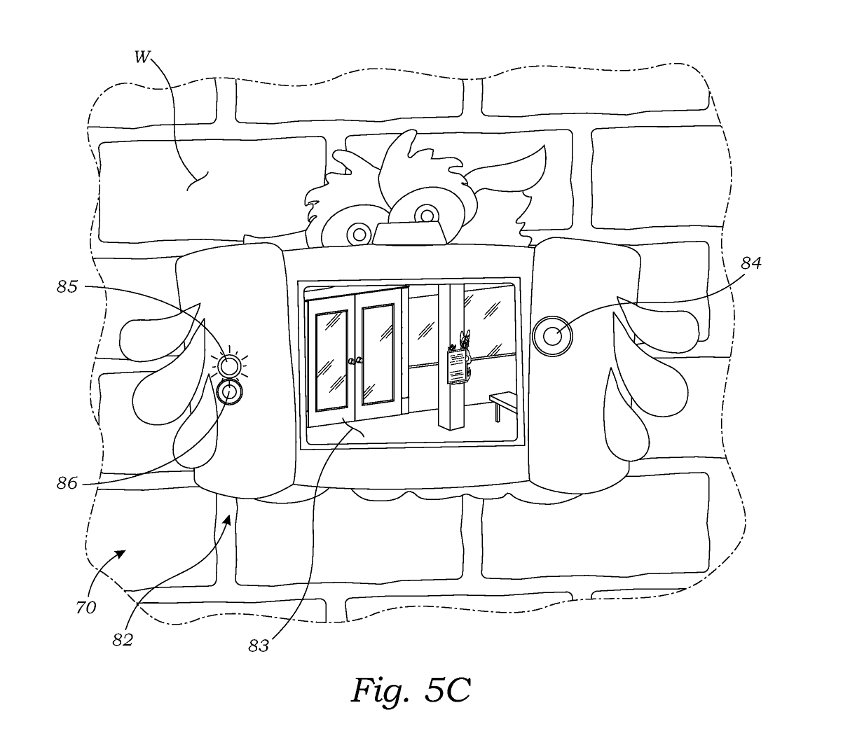

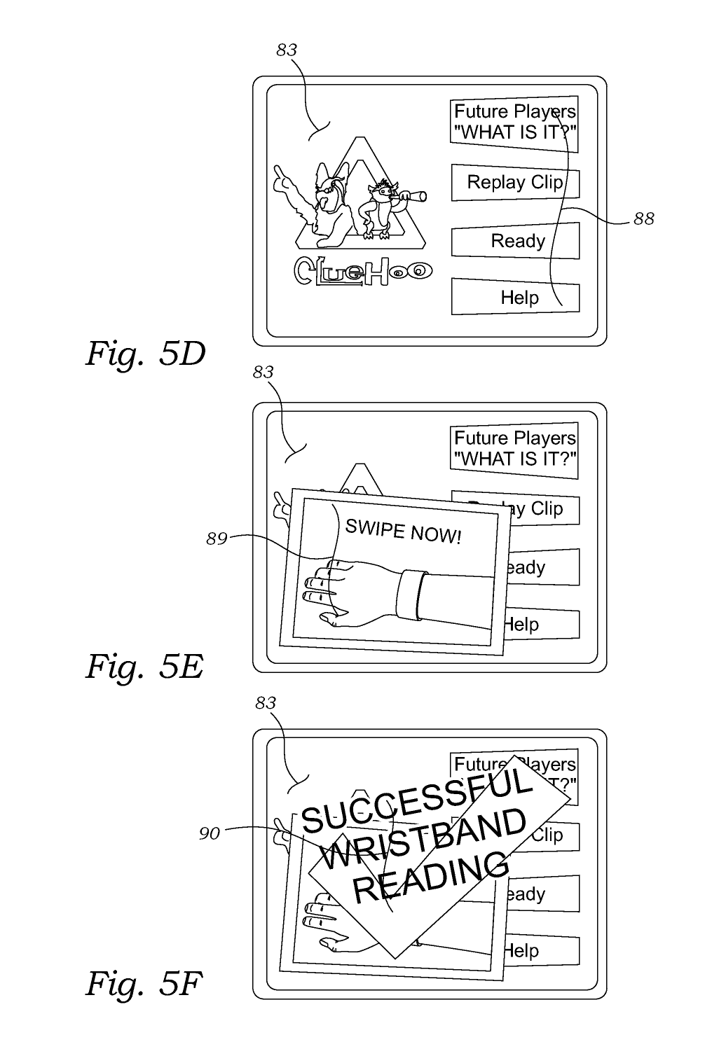

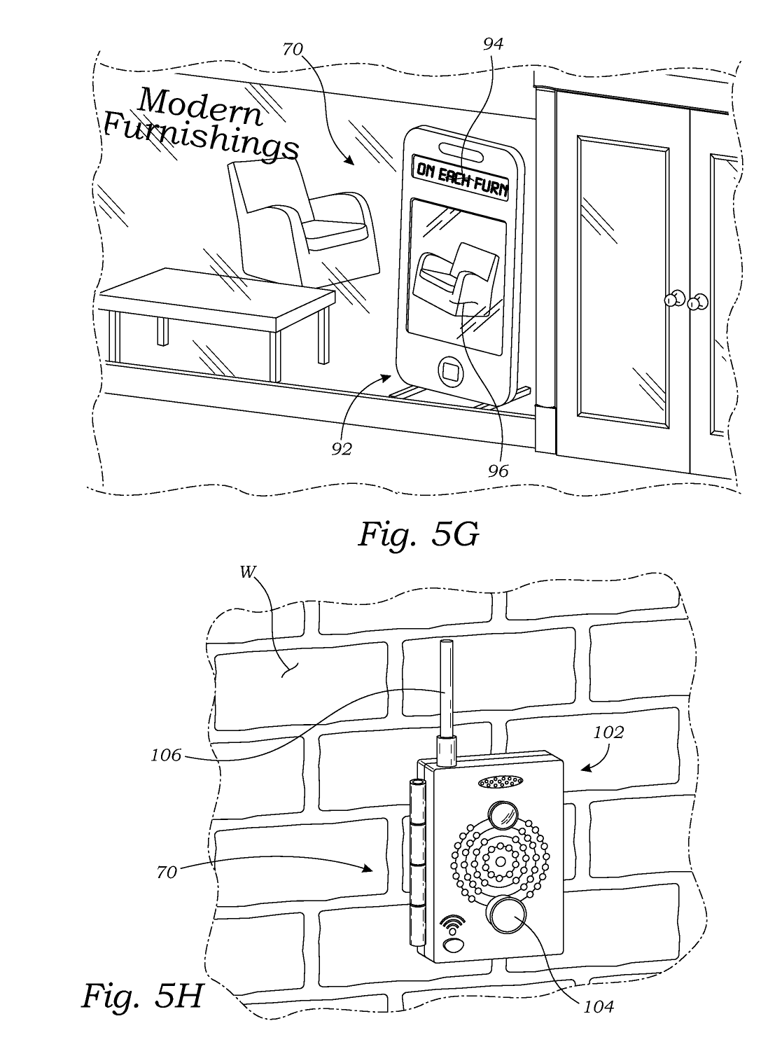

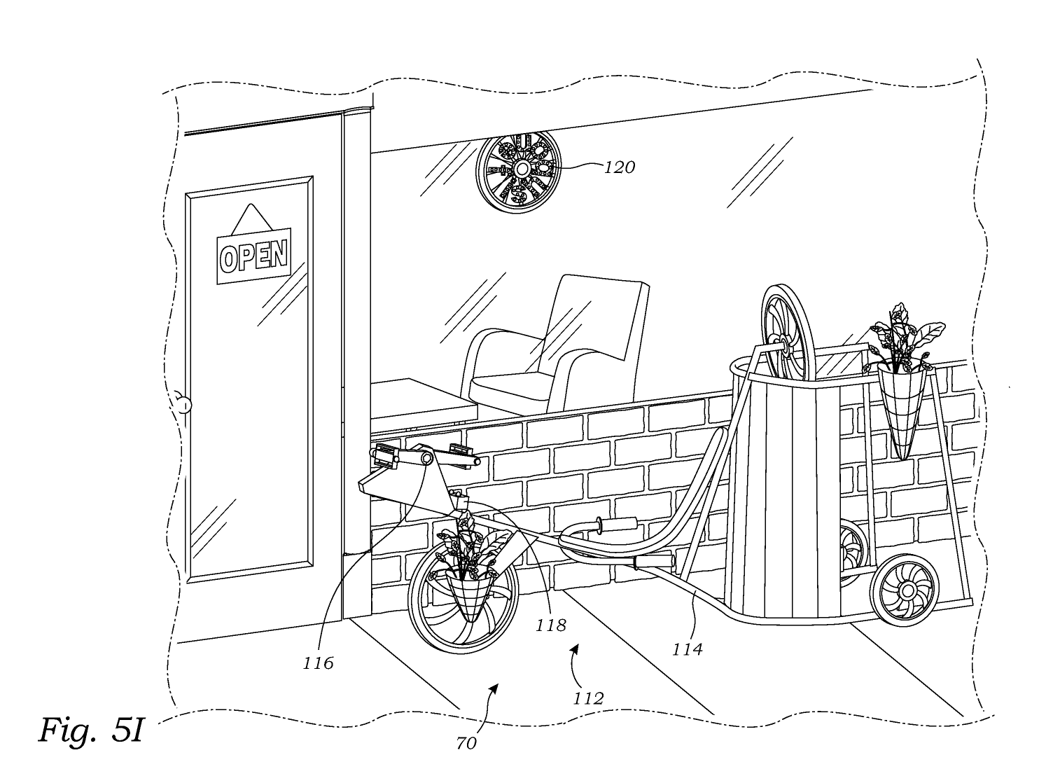

The system 20 further includes in the exemplary embodiment a start post 50 at which, as the name implies, the scavenger hunt game starts, which begins with a player using the interface 54 to enter the activation code 32 as provided by the network host 30, and specifically the participant management module 31, through the mobile device app 40 so as to access an adventure kit 58 via a dispenser 56 configured within the start post enclosure 52. The interactive scavenger hunt system 20 is further shown in FIG. 1 as including one or more signs 60 that may provide information or clues in the course of game play, as best appreciated in connection with FIGS. 4A and 4B described below, and one or more interactive devices 70 also employed during game play as appreciated from the below discussion of FIGS. 5-11.

Finally by way of general overview, the system 20 may include one or more prizes 200 in the form of, for example, vouchers for use in concessions, transit, or events and mementos upon completion of a stage of the game or the entire game, more about which is also said below. Those skilled in the art will appreciate that while particular components of such an interactive scavenger hunt system 20 are shown and described herein, the invention is not so limited, but may take a wide variety of forms and thus related devices and steps without departing from the spirit and scope of the invention, such that the particular exemplary embodiments disclosed are to be understood as being merely illustrative of aspects of the invention and non-limiting.

Referring to FIG. 2, there is shown a flow chart depicting an exemplary method of use or of providing such an interactive scavenger hunt system 20 as depicted in FIG. 1. At step 210, a website and related smartphone app or the like software are created and made available to facilitate game play as herein described.

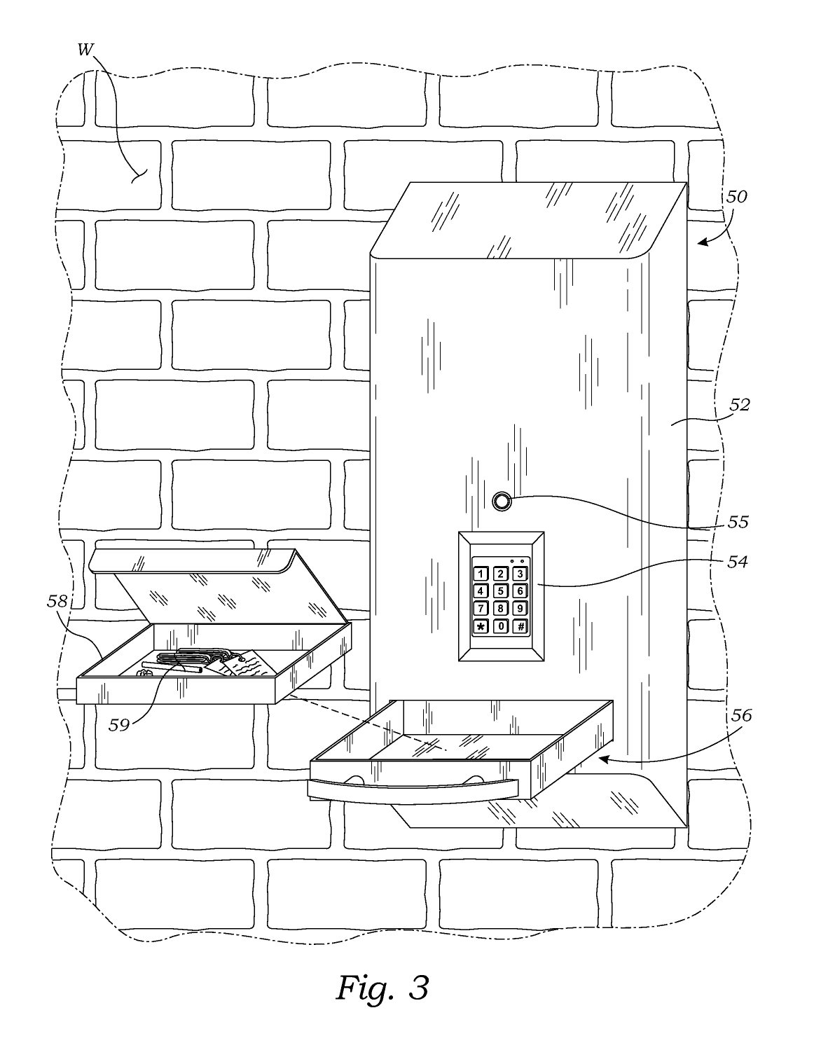

It is not anticipated that the invention can be readily practiced without such software and the network devices on which such software is installed and rendered operable, though it will be appreciated that any such computing devices, and particularly smart phones and other such wireless communication devices, whether now known or later developed, may be employed without departing from the spirit and scope of the invention and further that particularly any such wireless communication devices are not themselves part of the disclosed and claimed system and method. At step 212, one or more custom posts 50, signs 60, and interactive devices 70 are designed and developed, and at step 214 such items are installed throughout the area where the game is to be played or the scavenger hunt is to be conducted, more about which is said below in connection with FIGS. 3-11.

It is noted that the selection of locations and the manner and sequence in which the various posts 50, signs 60, and interactive devices 70 are then installed thus defines the game route and sequence from start to finish, each such route being essentially fixed, though it will be appreciated that variations of the same route, such as going in reverse, or various routes within the same geographical area, such as might use some but not all of the same posts 50, signs 60, and interactive devices 70, such as to “mix things up” for repeat participants or simply vary the level of difficulty or rough length of time the game should take, are possible within the present invention. At step 216, registration information and/or a reservation request are sent by a user and received at the network host 30 (FIG. 1) via the website or mobile device app 40 (FIG. 1).

This is basically the step at which a user or player registers to schedule a game or hunt employing the system and method of the present invention, which would entail, among other things, provision of contact information, an indication of the requested location and date for the game and the number of players or teams, and payment received at the network host 30, with all such information being stored and processed within the participant management module 31 thereof. Next, though not shown, to the extent that any configuration or provisioning of the physical post(s) 50 (FIG. 3), sign(s) 60 (FIGS. 4A and 4B), and interactive device(s) 70 (FIGS. 5-10) is required based on the participant's selected game/route, that is handled prior to the game date indicated in the participant's registration at step 216.

Then at step 218 the reservation is confirmed, and at step 220 an activation code used to initiate the game/hunt and related directions, both as to game play and to the physical location of the start post 50 (FIGS. 1 and 3), are sent to the user/player that made the reservation. At step 222 the user/player, having received the activation code, such as on his/her smartphone or other such mobile device, enters the activation code on the user interface 54 of the start post 50 (FIGS. 1 and 3) and thus the game/hunt begins, more about which will next be said in the context of the various exemplary posts 50, signs 60, and interactive devices 70 according to aspects of the present invention.

Turning now to FIG. 3, there is shown a perspective view of an exemplary start post 50 according to aspects of the present invention as installed on a wall W. As stated immediately above, at step 222 in the flow chart of FIG. 2 depicting use of the system and method, a user/player has proceeded to the start post 50 as instructed and has entered the provided activation code at the user interface 54 of the start post 50, here shown configured as a conventional keypad, though those skilled in the art will appreciate that any user interface, such as touch screens or the like, now known or later developed, may be incorporated into the start post 50 without departing from the spirit and scope of the invention.

The start post 50 itself is shown as having an enclosure 52 in which is installed the user interface 54 and an activation button 55 and related circuitry (not shown) as well as a dispenser 56. In use, once the activation button 55 is pressed then the activation code entered on the keypad 54, the dispenser 56 is unlocked or otherwise is activated so as to provide or render accessible an adventure kit 58 housed therein.

As shown, the adventure kit 58 may contain one or more items 59 that are employed in playing the scavenger hunt game, such as identifying necklaces, bracelets or rings to be worn by the participants and gadgets and the like that may be employed later in the game, such as to facilitate interaction with an interactive device 70 (FIGS. 1 and 5-11). The first clue may also be contained within the adventure kit 58 or otherwise be provided at the start post 50, such as placed on or in the enclosure 52 or displayed on the user interface 54 in the case of a touch screen or other such display device, or may alternatively be provided directly to the user's smartphone or the like, whether before or after the activation code is entered at the start post 50.

In any case, it is expected that the players will take the entire adventure kit 58 with them during game play and not leave it or any of its contents at the start post 50, not knowing what might be needed later during the scavenger hunt. It will be appreciated that the start post 50 can take a number of forms beyond that shown and described, such that the exemplary enclosure 52 configuration and its installation on a wall W is to be understood as being merely illustrative of aspects of the present invention.

Similarly, the adventure kit 58 and its contents 59 can vary widely even from game to game and certainly in various exemplary embodiments of the invention, such that the present invention is not so limited. Referring again to FIG. 2, with the player/user having arrived at the start post 50 and entered the activation code, at step 224 the adventure kit 58 (FIGS. 1 and 3) is dispensed and at step 230 the first clue is provided in a manner such as above-described.

Access to the adventure kit 58 within the enclosure 52 can be limited by requiring the participant to push the activation button 55, enter the activation code 32, or unlock a dispenser on the start post 50. It is further contemplated that the participant must push the activation button 55 prior to entering the activation code. Limiting access to the adventure kit 58 means limiting the access to the adventure kit 58 only to specific individuals who have registered for the interactive scavenger hunt system 20 either by way of the mobile device app 40 running on a mobile device or through a website.

The adventure kit 58 contains the items 59 and at least one of the items 59 must be used with the interactive device 70 to complete the scavenger hunt. The game then proceeds to lead the user(s)/player(s) to various locations based on clues provided sequentially; as indicated at step 232, subsequent clues may be obtained through entry of codes via the mobile device app 40 (FIG. 1) running on a user's smartphone or other mobile device, which codes are themselves obtained during game play, as through arrival based on a previous clue at or interaction with a sign 60 or interactive device 70, either of which may also be described more generally as a “post” along the “trail” of the interactive scavenger hunt.

That is, with each clue solved the participant will obtain another code that is entered on the smartphone app 40 (FIG. 1), which code is somehow derived from the posts 50, signs 60, and interactive devices 70 along the way. If at any point a participant enters an incorrect code the app will display an error message and invite the participant to re-enter the code, which may require a fresh look at the previous clue or a retry of some interaction with an interactive device 70, as will be appreciated from the further exemplary embodiments described below.

More generally, it will be appreciated that the words “clue” or “clues” and “code” or “codes” may be used interchangeably throughout, with the exception of the specific activation code required for game initiation, as each is related one to the other and each is obtained during game play, such that the clue or code derived at any point along the way at or through a post 50, sign 60, or interactive device 70, is what is employed in conjunction with the mobile device app 40 to obtain subsequent clues/codes. If a participant is struggling regarding a clue or code or any aspect of game play more generally, is having any “technical difficulties,” etc., as indicated in FIG. 1, the network host 30 includes a support module 37 for that very purpose, which might entail actual phone support or digital content support as by email or text messaging or web interfaces or the like, including “chat” and other such communication technologies now known or later developed, any or all of which the participant would be able to access or take advantage of via his/her smartphone or other such device, particularly the device on which the app 40 is running and through which game play is being facilitated.

Participants might also, at their own discretion, choose the option of skipping any of the posts 50, the signs 60, or the interactive devices 70 after the participants enter a wrong code. One other support feature is inherent to the smartphone or other device and is enabled by the app 40 running thereon—GPS capabilities.

The idea here and a means for assisting participants during play is to employ GPS-enabled support so as to verify a participant's physical location and that they are physically, spatially following directions according to the stage in the game the participant is at and so alert the participant as by a “pop-up” message on their phone or other device that they are deviating from the defined route and direct them back to the route. This GPS functionality as part of the support module 37 also enables customizable selection of “real-time” “pop-up” information and alerts relating to venues along the route or not far off the route, such as food, restrooms, bus stops, points of interest, etc. It will be appreciated that the GPS feature will also help the support staff and function to remotely assist participants to get back on the defined route or “on track.” The GPS feature and functionality may also include actual coordinates, cardinal directions (compass), and/or altitude (altimeter) and can provide such data in absolute form or as relative to signs, gadgets or locations relevant to the game.

Referring next to FIGS. 4A and 4B, there are shown two exemplary signs 60 that may be incorporated into an interactive scavenger hunt system 20 according to aspects of the present invention. First, in FIG. 4A, there is shown a perspective view of a first exemplary sign 60 configured as a placard 62 bearing graphical content 64 (text and/or images) and mounted on a wall W.

Such graphical content 64 may in turn provide a clue or code for the participant, perhaps somewhere hidden within the placard 62, that is to be discovered and utilized to obtain the next clue. Any such sign 60 may also include a “Hoo challenge code” that is used in an optional timed challenge, more about which is said below.

In the alternative exemplary embodiment of FIG. 4B, the sign 60 is configured as a word or other graphical content 64 incorporated into an object 66, here a weather vane atop a roof R. Again, such word, indicia or other graphical content 64 may be a clue or code for the player to enter into the mobile device app 40 (FIG. 1) to obtain the next clue.

In the particular exemplary embodiment of FIG. 4B, the typical directional letters on a weather vane—“N”, “S”, “E” and “W”—along with other letters incorporated into the object—here such as the letter “I” being represented by or on the vertical support of the vane 66 itself—may be configured to light up in a certain sequence so as spell a word that is the code, for example “NEWS” or “SWINE” if the letter “I” of the support is employed.

As will be further appreciated from the numerous exemplary interactive devices 70 shown and described below in connection with FIGS. 5-11, a sensor, motion detector, or other device with which a participant knowingly interacts could cause the lights of a sign 60 such as the exemplary weather vane 66 shown in FIG. 4B to light up or perform some other function from which a clue or code might be derived. Those skilled in the art will appreciate that a virtually endless variety of signs 60 may be adapted for use according to aspects of the system and method of the present invention, such that the two signs shown and described are to be understood as being merely illustrative.

It will be further appreciated that any such signs 60 may be installed on or incorporated into such city objects as walls and buildings, weather vanes on roofs, sidewalks and streets, lampposts, fountains, statues, etc. (i.e., ordinary city objects) thereby increasing the fun of the search as the one or more players navigate a city, for example, in seeking out clues in an attempt to complete the scavenger hunt.

Referring next to FIGS. 5-11, there are shown perspective views of a number of exemplary interactive devices 70 that may be configured and installed ahead of time throughout an area in which the scavenger hunt game according to aspects of the present invention is being played, once more with a player being led to each such device 70 by a previous clue, and then each device, based on the player's interaction therewith, typically providing a further clue based on which the hunt can continue, or a code that, once entered in the mobile device app 40, may then provide or lead to a subsequent clue, as again generally comprising step 232 of FIG. 2. For example, referring first to FIG. 5A, the interactive device 70 is shown as a scanner/reader 72 having a source/receptor 73 incorporated therein.

The source/receptor 73 can emit communicative signals including RF, bluetooth, ANT, WiFi, NFC, IR, and other similar signals. The communicative signals can be received by a synchronized device with a pairing signal then returned to and registered by the source/receptor 73. As such and as shown, a player may wear a bracelet or wristband 74 around his/her arm A that is configured with the appropriate scannable code or chip so as to be positively identified by or positively interact with the scanner/reader 72, and the source/receptor 73, specifically.

Then, the scanner/reader 72 having linked or paired with or otherwise received from the wristband 74 the appropriate information may itself provide the next code or clue to the player, either visually or audibly or by turning on or activating some other device in the vicinity (not shown in FIG. 5A, but which could be, for example, the “light up” letters on the weather vane 66 of FIG. 4B) or even by simply sending a wired or wireless signal back to the network host 30 (FIG. 1) so that the next clue can be provided to the player via the mobile device app 40. The scanner/reader 72 is shown as being mounted on a pole P, but it will be appreciated that it could be installed most anywhere.

Again, the player would presumably have only been in the vicinity of the scanner/reader 72 and/or known to look for it based on properly following a previous clue that led him/her there. It will be appreciated from the above discussion that the armband 74 may have been provided, for example, among the other items 59 found in the adventure kit 58 dispensed from the start post 50 at step 224 (FIGS. 1-3), thus again illustrating the importance of beginning at the start post 50 and of porting the items 59 obtained at the start post 50 with a player during the hunt.

Turning next to FIG. 5B, there is shown an alternative interactive device 70 configured as a motion detector/player 76 equipped with a motion detection sensor 78 and a motion detector speaker 80. In practice, a player would approach the motion detector/player 76 as by causing an arm A, hand H, or other body part or object to pass in front of the sensor 78, once again presumably due to having followed a previous clue to the area, and to the motion detector/player 76, specifically, which would in turn detect the presence of the person (motion) via the sensor 78 and, in response, would again then provide some visible or audible response or cause some other action through sending a signal or the like—here, by playing music or other audible information via the motion detector speaker 80—which again may thus provide a needed clue or code for the player to continue in the hunt or game. The motion detector/player 76 is shown as mounted on a wall W, though just as with the scanner/reader 72 mounted on a pole P, it will be appreciated that any such installation of such interactive devices 70 is any real sense arbitrary and can vary as needed or desired in a particular context.

Turning to FIG. 5C, there is shown yet another exemplary embodiment of an interactive device 70, here configured as a multi-function gadget 82. The gadget 82 includes a touchscreen 83, a built-in camera having a camera lens 84 and flash 85, and a speaker 86.

In use, the multi-function gadget 82 may prompt participant interaction through the touchscreen 83, which may in turn lead to visual instructions or information thereon or auditory instructions or information through the speaker 86. At some point, the gadget 82 may even prompt the player(s) for a photo, which may then be transmitted through a wired or wireless connection to the participant's smartphone or directly to the network host 30 as part of game play or just as a fun “record” of the player(s) during the game.

Though not shown, it will be appreciated that such a multi-function gadget 82 may thus include an RF or Wi-Fi transmitter or any other such transceiver or communication device now known or later developed for the purpose of communicating with other devices, whether local or remote. The gadget 82 may also include, though again not shown, an RFID reader or other such sensor for reading a wristband or the like in a manner similar to that described above in connection with FIG. 5A.

With reference now to the related FIGS. 5D-5F, there are shown schematics of various screen displays as might be displayed on the touchscreen 83 of the multi-function gadget 82 during use. First, in FIG. 5D, there is shown an exemplary first graphic 88 that may provide or provide interactivity to information about game play, both for current and prospective participants.

Depending on the context, use of or navigation within the touchscreen interface 83 may be limited to just participants, as might be controlled by entry of a code or scanning of an identifier. For example, in FIG. 5E, based on a participant's interaction with the gadget 82 and based on the gadget 82 having an RFID reader or other sensor (not shown in FIG. 5C, but analogous to sensor 78 in FIG. 5A), the touchscreen 83 displays a second graphic 89 instructing the participant to scan or swipe his or her wristband 74 (FIG. 5A). Then, assuming that the wristband 74 or other identifier is valid and properly “read” or scanned, as shown in FIG. 5F, a third graphic 90 may be displayed on the touchscreen 83 indicating that there was a successful reading, which may then allow other functionality of the multi-function gadget 82 to be activated or become accessible.

Turning next to FIGS. 5G-5I there are shown three still further alternative exemplary embodiments of interactive devices 70 according to aspects of the interactive scavenger hunt system 20 of the present invention. First, in FIG. 5G, there is shown a phone gadget 92 configured as essentially an over-sized smartphone as might be employed in a retail establishment of some kind.

Activation of a nearby sensor or other such device in a manner as described herein may thus cause content to be displayed on the phone gadget 92 that provides a needed clue or code. In the exemplary embodiment, the phone gadget 92 includes a first phone display 94 that might contain text and a second phone display 96 that might contain graphics, though it will be appreciated that any number, type(s), and content of displays may be incorporated into the phone gadget 92 without departing from the spirit and scope of the invention.

A built-in electronic control unit (not shown) may be incorporated into the phone gadget 92 and configured to interact with the displays 94, 96 and any other interactive device, such as the multi-function gadget 82 (FIG. 5C) here serving as a wireless activator, so as to trigger display of the desired content. It will thus again be appreciated that any particular interactive device 70 according to aspects of the present invention may be interacted with directly or indirectly, as through another interactive device 70 wired or wirelessly connected thereto.

In FIG. 5H there is shown a camera gadget 102 having a camera lens 104 and a camera antenna 106, which may again be configured to wirelessly, as here through the antenna 106, communicate with another interactive device 70 so as to take a photo of one or more players and transmit the photo as part of game play. And in FIG. 5I, there is shown an interactive device 70 configured as a lights gadget 112 configured as a stationary bicycle of sorts having a frame 114 and a crank generator 116 that, when turned, as by hand or foot, may light up letters on a light display 120 electrically connected thereto in a particular sequence or just at all rather being darkened, somewhat like the sign 60 configured as a weather vane 66 as shown in FIG. 4B, so as to display or indicate a word or series of letters that is the code needed to enter in the app 40 (FIG. 1) and thereby receive the next clue in the adventure.

In the exemplary embodiment, the lights gadget 112 is further configured with activation progress lights 118 coupled to the crank generator 116 so as to indicate to the user what progress they have made with the crank generator 116 and how much more pedaling is required to charge the unit and allow the light display 120 to illuminate, spin, or take whatever action is needed in order to display the code word or clue. Once more, those skilled in the art will appreciate that while particular embodiments of interactive devices 70 have thus been shown and described, the invention is not so limited, but may instead take a virtually infinite number of forms without departing from the spirit and scope of the invention.

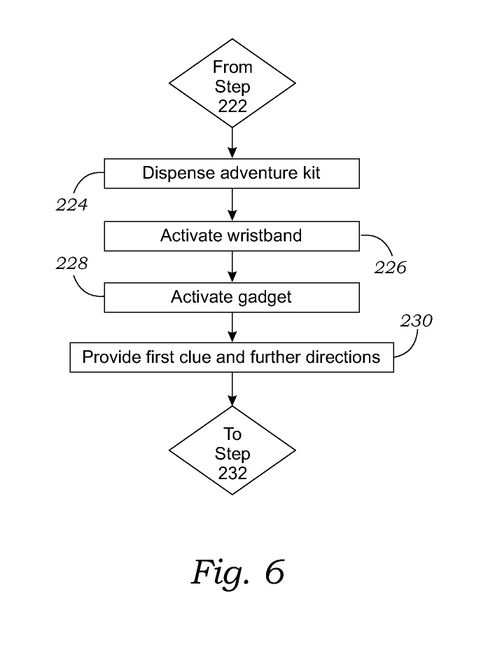

As shown in FIG. 6, a flow chart alternative to FIG. 2, additional steps may be employed between step 224 of dispensing the adventure kit 58 (FIGS. 1 and 3) and step 230 of providing the first clue and other directions, which it will be appreciated may be facilitated by interactive devices 70 such as those shown and described herein, particularly the multi-function gadget 82 having a touchscreen display 83 as shown in FIG. 5C. That is, in further use of or interaction with the gadget 82, the touchscreen 83 may optionally display a question as part of activation of a participant's wristband 74 (FIG. 5A) that only a participant would know the answer to, with the correct answer then serving to activate the wristband as indicated at step 226.

The user would then be instructed, again by way of the touchscreen 83 of the gadget 82, where to find another interactive device 70 in the vicinity; once finding it, the participant with the activated wristband would then effectively activate the gadget and the entire game by scanning the wristband 74, in a manner as shown in FIG. 5A as an example, and then would be required to come back to the gadget 82 within a certain amount of time after activating the other device 70, thereby complete gadget activation as at step 228 in FIG. 6. Again, those skilled in the art will appreciate that such an activation sequence for either or both the wristband 74 and gadget 70 is exemplary and that numerous other means of activating both are possible in the present invention, depending on the technologies employed and a number of other factors. This, it will be appreciated that the alternative method shown in FIG. 6 is merely illustrative of features and aspects of the present invention and non-limiting.

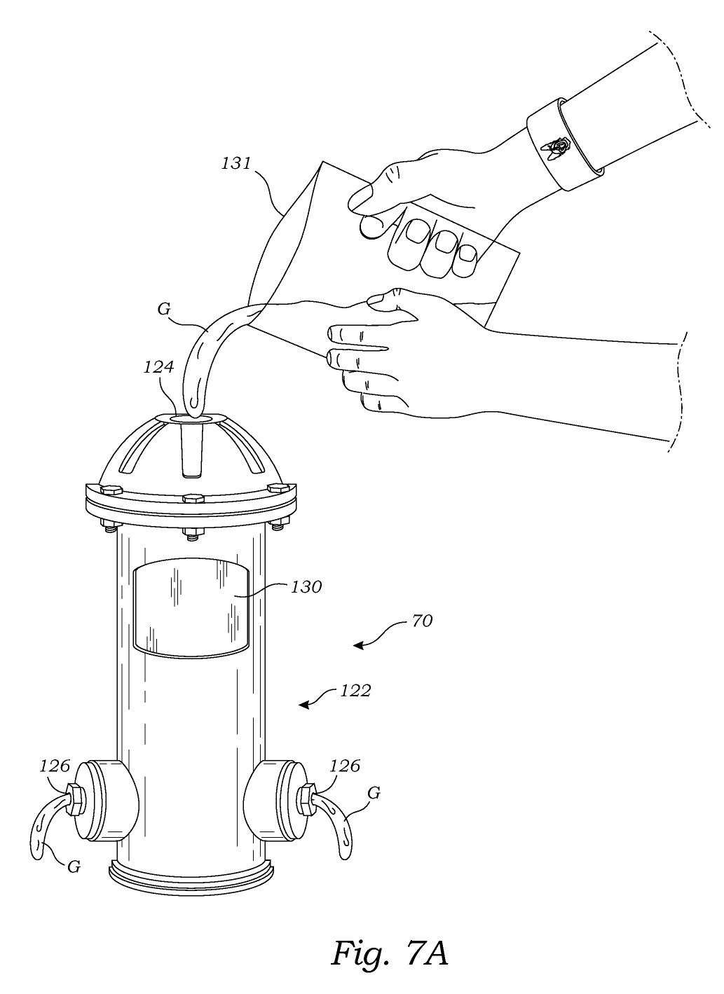

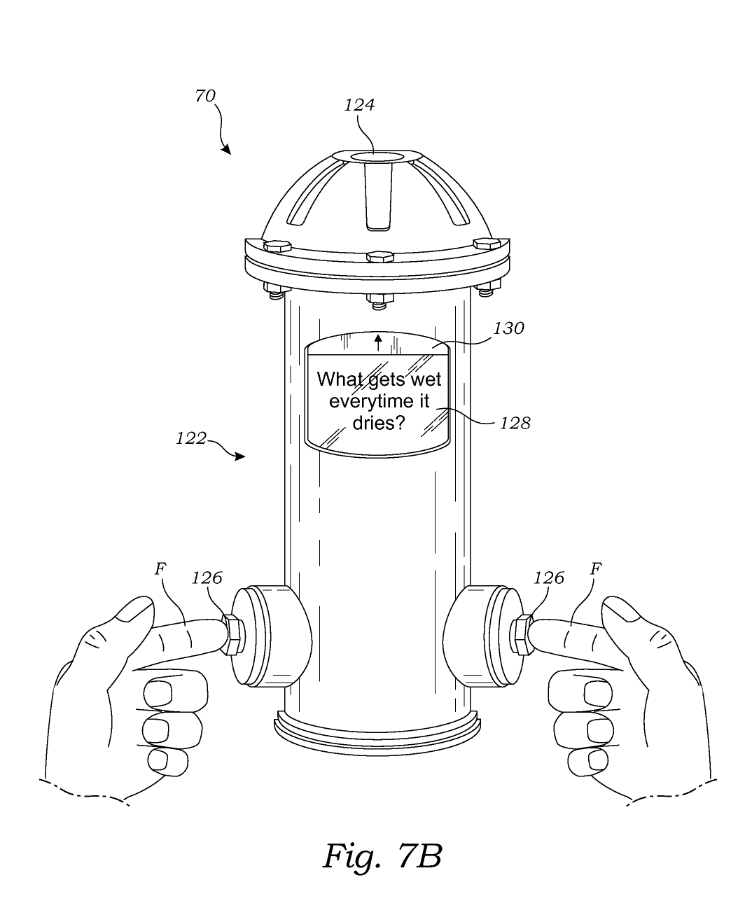

Referring next to FIGS. 7A and 7B, there is shown yet another exemplary interactive device 70, here in two operational states or modes and generally being characterized as more mechanical in nature, though it will be appreciated that many such devices, including that of FIGS. 7A and 7B and that of FIG. 5I, are both mechanical and electrical in structure and operation. The interactive device 70 is configured basically as a display device 122, here having the appearance or taking the form of a fire hydrant.

With reference to FIG. 7A, in the first operational mode, a player pours water G into the top inlet 124, once more presumably based on a previously received and deciphered clue, which water G then just runs out of two lower outlets 126. In a second operational mode of the display device 122, as shown in FIG. 7B, a user then plugs the two outlets 126 using his/her fingers F to cause the water level within the display device 122 to rise. As the water level rises, a swimmer or floating element (Not Shown) within the display device 122 will rise as it floats on the water within the display device 122.

It is contemplated that the swimmer can be mounted to a vertical guide rod (Not Shown) and move in the same vertical direction as the water level. The swimmer can lift clue or code 128 into a message window 130 to reveal a clue or code 128. The clue or code 128 can then lead the player to the next stop in the hunt.

Once more, those skilled in the art will appreciate that all such interactive devices 70, and any such display devices 122 particularly, may be modified and varied from those exemplary embodiments shown without departing from the spirit and scope of the invention. It will be appreciated that a bag 131 or other such object as shown in FIG. 7A as being used to contain the water G and pour therefrom, may have also been provided in the adventure kit 58 (FIGS. 1 and 3), providing a further example of the value and importance of keeping the kit 58 with a participant throughout the game.

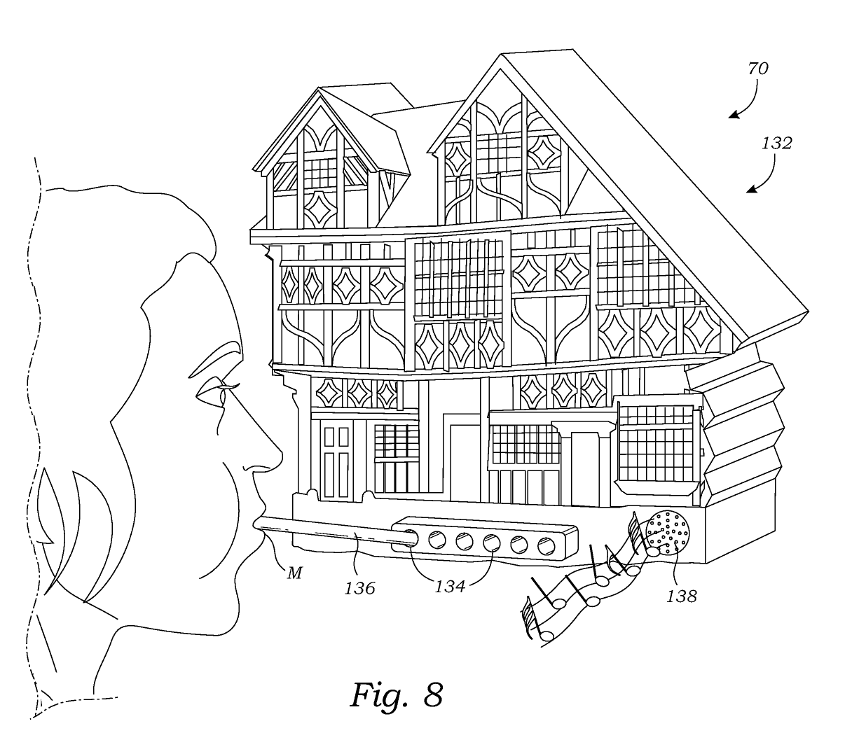

Relatedly, referring now to FIG. 8, there is shown yet another illustrative interactive device 70, here configured as a blower/player 132. The blower/player 132, which may again be located or mounted virtually anywhere and would be identified and found by a player based on a previous clue received or obtained during game play, is configured with multiple blow holes 134, which when blown into as by using a straw or tubing 136 in a player's mouth M, which tubing 136 may again have been included in the adventure kit 58 (FIGS. 1 and 3), may then cause the blower/player 132 to emit music or other audible sounds from an included blower speaker 138 that themselves provide the player with yet another clue in the scavenger hunt. The blower/player 132 is shown as depicting a chalet or other such building, but it will be appreciated that it can take numerous forms and that such details are decorative and non-limiting of the invention. It is further contemplated that the interactive device 70 can produce visual clues or entertainment as the blower/player 132 engages with the interactive device 70.

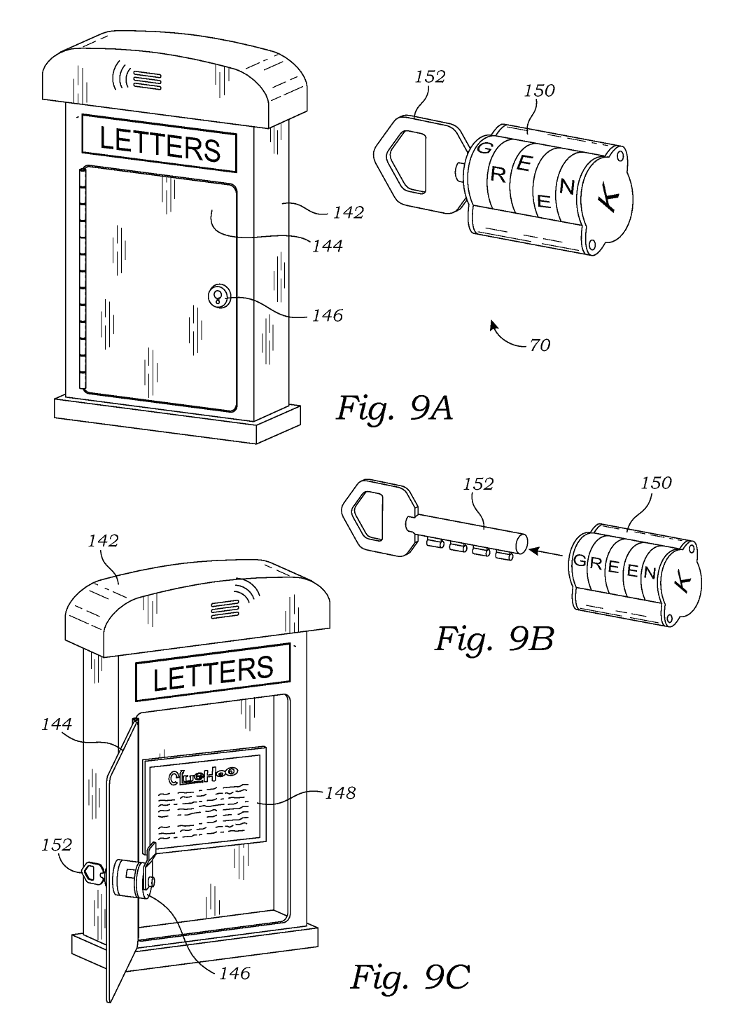

Turning next to FIGS. 9A-9C, there is shown yet another exemplary interactive device 70, here involving two distinct devices that work in tandem. First, there is shown a box gadget 142 configured somewhat as a mailbox and having a box door 144 that is initially locked by a box lock 146.

Separately, as also shown in FIG. 9A as comprising the exemplary interactive device 70, there is a key lock 150 in which is retained a key 152 configured to open the box lock 146. But the key 152 is retained in the key lock 150, which is itself configured as a combination lock, until the appropriate combination is entered on the combination lock 150, such as the word “GREEN” as illustrated in FIG. 9B, whereby the key 152 is then released from the key lock 150, which combination would be a code previously acquired as by solving a clue or taking other action as needed as part of game play in order to determine the combination. Then, as shown in FIG. 9C, the key 152 having now been freed from the key lock 150 (FIGS. 9A and 9B) is inserted in the box lock 146 so as to open the box door 144 and thereby gain access to a box message 148 contained therein, which again may be another clue in the continuation of the scavenger hunt adventure.

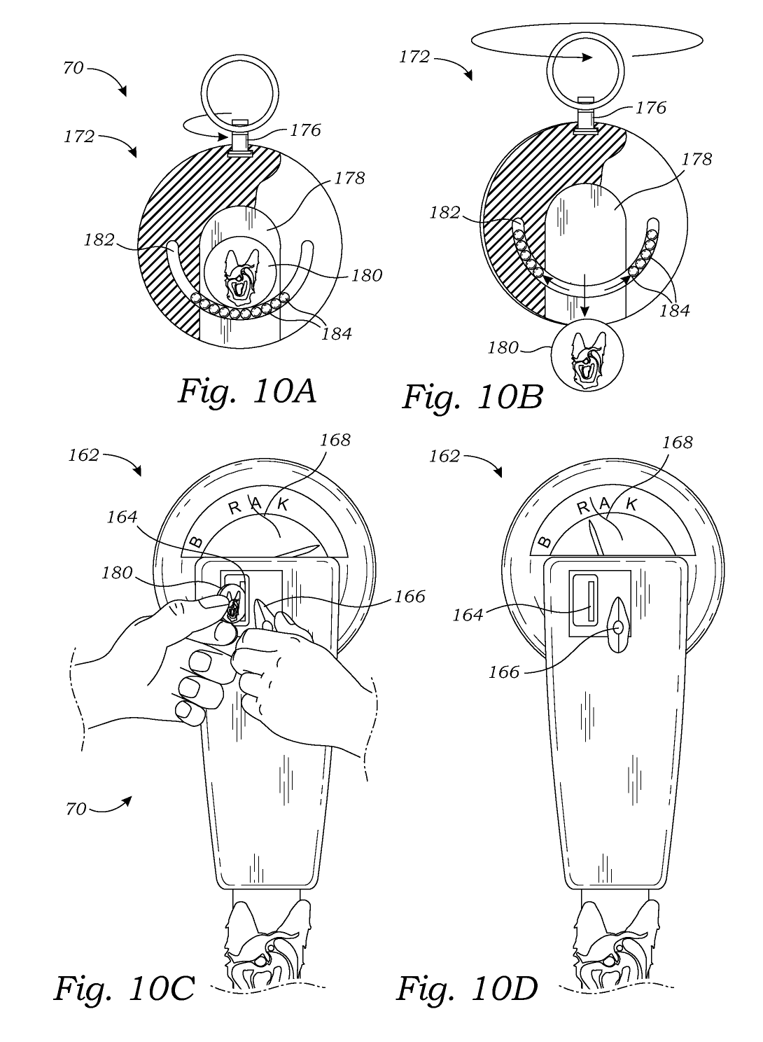

Much like FIGS. 9A-9C, in a still further exemplary embodiment of an interactive device 70 according to aspects of the present invention, there is again shown in FIGS. 10A-10D such a device involving two distinct devices that work in tandem. First, in FIGS. 10A and 10B there is shown a coin gadget 172 generally having a housing 174 and a pivot 176 formed therein so that the housing 174 can be spun about its vertical axis.

Within the coin gadget housing 174 there is formed a coin channel 178 that contains within it a coin 180 and further a bead channel 182 configured to connect or communicate with the coin channel 178, the bead channel 182 housing beads 184 running therein and able to shift therealong. In an “at rest” configuration of the coin gadget 172, the beads 184, as by gravity and based on the concave or upward curvature of the bead channel 182, settle substantially at the bottom of the bead channel 182 and thus across the coin channel 178, thereby retaining the coin 180 within the coin channel 178.

Then, as the coin gadget 172 is spun on its axis via the coin gadget pivot 176, the inertial effects tend to pull the beads 184 upwardly and radially outwardly in the bead channel 182 as shown in FIG. 10B, whereby the coin 180 is then free to fall through the coin channel 178 and out of the coin gadget housing 174. Those skilled in the art will appreciate that a variety of geometrical and functional configurations of the coin gadget 172 are possible without departing from the spirit and scope of the invention.

With reference now to FIGS. 10C and 10D, the other portion of the exemplary overall device is shown as a dial gadget 162 configured much like a curbside parking meter, as such having a coin slot 164, a dial 166, and a display 168 having letters around a half-circle printed region rather than minute increments or the like; to be clear, in the exemplary embodiment, the dial gadget display 168 comprises both a printed or other visual region and a needle moving or passing over the visual region, which components of the display 168 may be physical or virtual. In use, as first shown in FIG. 10C, the coin 180 acquired from the coin gadget 172 as above-described in connection with FIGS. 10A and 10B is inserted in the dial gadget slot 164.

Then, the gadget dial 166 is turned to accept the coin 180 and “feed the meter,” the winding of the dial 166 pegging the needle on the right as in a parking meter, but here with letters on the display 168 rather than time increments. Then, as time ticks off (the needle still moving as time passes), the participant is instructed via the app 40 (FIG. 1) or perhaps a previous clue regarding when to note the letter to which the needle is pointing on the display 168, with the letters so selected based on times to “mark” or note the letters being used to spell a word or otherwise provide a code that is entered in the app 40 in order to get the next clue. Once more, those skilled in the art will appreciate that a variety of electrical, mechanical, electro-mechanical and other such devices may be employed in the present interactive scavenger hunt system without departing from its spirit and scope, such that the exemplary embodiments should be seen as illustrative of features and aspects of the invention and non-limiting.

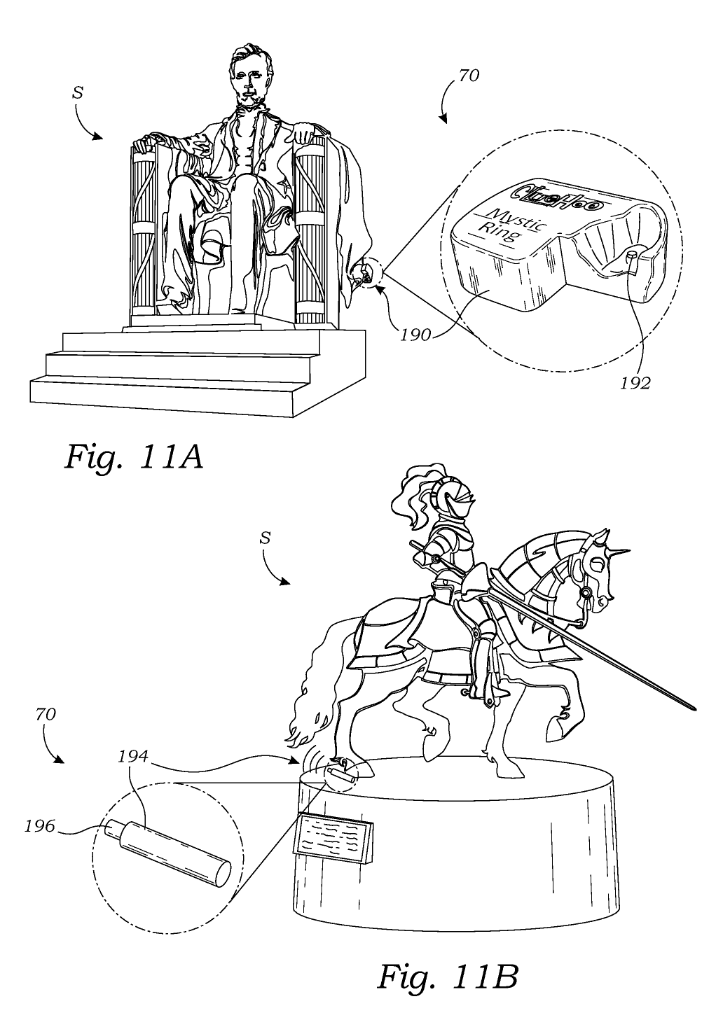

Referring finally to FIGS. 11A and 11B in terms of various interactive devices 70 potentially employed in the present invention, there are shown two further exemplary “passive” devices, in the sense that they register or detect a signal such as might be sent by another device such as the wristband 74 (FIG. 5A) or the participant's smartphone simply based on the device being approached 70 closely enough. In FIG. 11A there is shown a ring gadget 190 positioned on or adjacent a statue S or other city object or the like, the gadget 190 having a ring gadget transceiver 192.

Similarly, as shown in FIG. 11B, a micro beacon gadget 194 may be positioned on or adjacent a statue S or city object in much the same way, the micro beacon gadget having a transceiver 194 and generally just having a smaller size or profile than the ring gadget 190, each of which might be better suited to one installation or use versus another, and both of which having a respective transceiver 192, 196 is configured to send out wireless signals that can be captured by a smartphone or other such device that is within the reach of the signal.

In fact, when “paired” with a smartphone running the app 40 (FIG. 1), the ring or micro beacon gadget 190, 194 may provide a signal strength based on the distance away, or the distance from the smartphone to the gadget, and so display that signal strength visually and/or audibly via the smartphone, whereby the player can “zero in” on the target object at which the ring or beacon is hidden, and thus solve or find another clue in the game. In one exemplary embodiment, the content on the smartphone display comes into greater and greater focus the closer the user gets to the target. Various other interactive devices 70 beyond those shown and described in connection with FIGS. 5-11 may be employed according to aspects of the interactive scavenger hunt system 20 without departing from the spirit and scope of the invention.

Accordingly, and more generally, with such posts 50, signs 60, and/or interactive devices 70 placed throughout a city, town, neighborhood, or other area, clues derived therefrom in conjunction with the mobile device app 40 installed on the smartphone or other mobile device of one or more players thus lead a player or team from location to location in a unique interactive scavenger hunt according to aspects of the present invention. To complete FIG. 2, then, employing such devices in any manner appropriate to a particular game or context, at step 234 at or in conjunction with a particular post 50, sign 60, and/or interactive device 70, a prize 200 (FIG. 1) in the form of an item or activity voucher may be provided and redeemed so that a player or team may receive a food or beverage item, admission to an entertainment event, transportation, such as bus or subway fare, or other such “perks” as part of game play, both as a reward and/or as a means of getting to another clue.

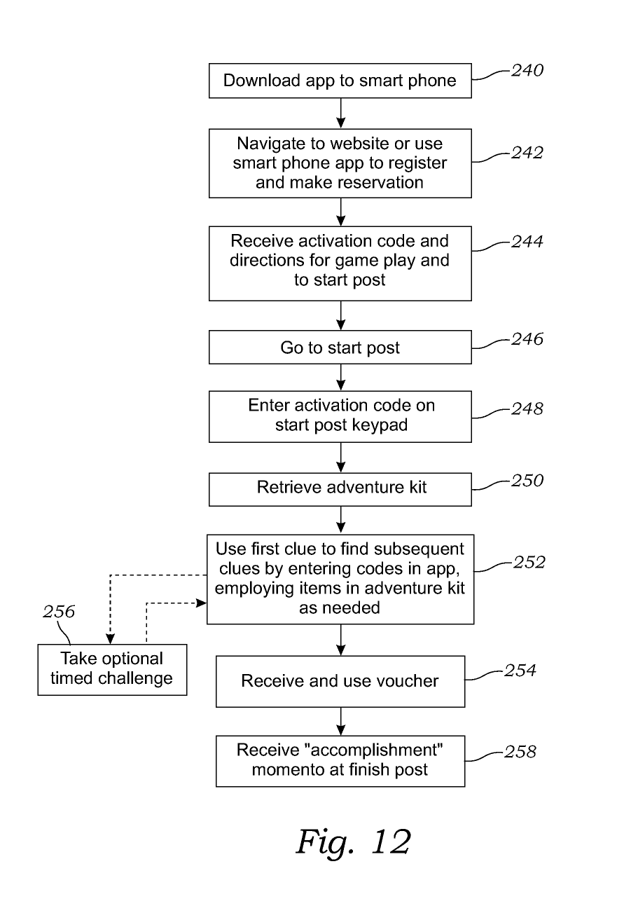

Further, at any point based on a previously provided clue or other prompt during play, such as through a message sent or displayed via the mobile device app 40 (FIG. 1), any player or team may separately, whether as part of the same scavenger hunt or game or independent of it, be provided with and take an optional timed challenge at step 236, more about which is said below in connection with FIG. 12. Finally with reference to FIG. 2, at the end of the scavenger hunt, at step 238 a player or team may be provided with a prize 200 (FIG. 1) in the form of an “accomplishment” momento of some kind (e.g., trophy, medal, etc.).

There are further educational and social aspects of the game during play as well, beyond the fun, the teamwork and camaraderie, and the mental challenges of the clues and gadgets. As shown in FIG. 1 and mentioned above, first, the network host 30 includes a learning module 35 that “pushes” learning content to the participant via the app 40.

This content could be interesting and educational information about places and objects, both textual and visual/audio-visual, typically specific to the route or game being played, and thus particular to even buildings, objects, etc. encountered during the hunt, so as to again also be informative to the participant as the game is played. The information may be presented to the participant via the app 40 in a user-directed way, as by making a selection to see “little,” “more,” or “a lot” of particular information or by simply activating/expanding or closing/shrinking a pop-up window containing the content or by pushing “play” or not regarding a video clip or other audio-visual content.

Similarly, regarding the social aspect of the game, the social media module 36 of the network host 30 can provide interaction with not only the host website itself but also to other social media sites and links so that, as a participant chooses, their progression along the route or hunt may be reported to or tracked by others in their “circle,” be that friends, family, co-workers, etc. In fact, a number of the interactive devices discussed herein and others like them that are equipped with transmitters and other means of communicating with the participant's phone or the like may thus be able to track the participant all the way through the game, both for letting others know of the progress made as the participant has pre-selected and even for internal tracking of the game/route for statistical data (e.g., how long it takes participants to move from one post or cluepoint to the next, how long it takes at each post or cluepoint before the clue is solved and the next code entered so as to get a new clue, etc.).

This will all aid in the overall interactivity and social aspects of the user experience with a scavenger hunt according to aspects of the present invention. As for support as above-discussed, the same transmitters that can track and report participant progress can also act as quality control devices, detecting and reporting on gadget malfunctions and the like, all of which is enabled based on the inner-operability of the various components and many of them being equipped with wireless transmitters, transceivers and the like.

In use, then, and with reference now to FIG. 12, a flow chart depicting the steps taken by a user in playing or participating in an interactive scavenger hunt according to aspects of the present invention, the typical first step 240, unless already done based on playing the game previously, is to download the mobile device app 40 (FIG. 1) to the user's mobile device (e.g., smartphone, tablet, etc., not shown), which app 40 then facilitates the scavenger hunt itself. At step 242, the user navigates to a website associated with the scavenger hunt or employs the downloaded app 40 to register and/or make a reservation for a hunt.

In response, from the network host 30 (FIG. 1), at step 244, the user receives, typically at the mobile device running the mobile device app 40 (FIG. 1), an activation code 32 (FIG. 1) and game sequence/directions 33 (FIG. 1). The directions 33 may include, among other things, confirmation regarding the game reservation, instructions about game play and what to expect, and directions to the physical location of the start post 50 (FIGS. 1 and 3) where the process would actually begin on the day of the interactive scavenger hunt.

Other such information can be provided at this step 244 or in subsequent steps, via any communication means now known or later developed. At step 246, the user actually proceeds to the start post 50 (FIGS. 1 and 3), and at step 248 the user enters the activation code on the start post interface 54 (FIG. 1), which in the exemplary embodiment is configured as a keypad (FIG. 3), as above described in connection with FIG. 2.

It will be appreciated that any user interface now known or later developed may be employed, such that the invention is not limited to the representative keypad 54 shown. For example, a touch screen or RFID reader could be used to enter or transmit the activation code 32.

Once the activation code 32 is entered, in the exemplary embodiment a drawer-type dispenser 56 (FIGS. 1 and 3) is rendered selectively openable as by being unlocked by the start post 50, such that at step 250 the user then accesses the adventure kit 58 (FIGS. 1 and 3). As above-described, the adventure kit 58 may contain one or more items 59 (FIG. 3) that are employed in playing the scavenger hunt game, such as identifying necklaces, bracelets or rings to be worn by the participants and gadgets and the like that may be employed later in the game.

The adventure kit 58 may also contain the first clue, or the first clue may be provided via the mobile device app 40. Either way, or using any other such means to provide the first clue, at step 252, the user employs the first clue to find subsequent clues by entering each code or word or other content provided as each clue is “solved” or “used” in the app 40 to get the next one, often employing one of the items 59 in the adventure kit 58 alone or in combination with other posts 50, signs 60, or interactive devices 70 (FIGS. 1 and 3-11) to solve each clue and obtain the needed code. And so the game would proceed until completion at step 258, such as arriving, as led by the clues, at a final destination, at which time each player may receive an “accomplishment” memento at the final post.

With continued reference to FIG. 12, at step 254, during game play one or more clues may lead the players to a location at which they either receive or redeem an item or activity voucher 200 (FIG. 1), the voucher 200 could include complimentary ice cream, museum admission, movie or show tickets, and bus or subway fare to assist the players in getting to the next location in the hunt. It will be appreciated from the foregoing that in some instances the vouchers may be physical, printed material or the like found along the way, as again being led by clues to certain locations, or may be “virtual” coupons or the like, equally redeemable, as provided directly to a player's smartphone or other such device once again in conjunction with the mobile device app 40 (FIG. 1).

Finally, optional step 256 relates to an optional “timed challenge” that one or more players may participate in at any point during the hunt. While the scavenger hunt is generally not timed, with individuals or teams able to go at their own pace with the primary fun and accomplishment just being to arrive at the final destination and know that the hunt was completed, there may be provided at different points throughout the game an optional timed challenge, most likely once again as dictated by the mobile device app 40, whereby one or more players from each team or as individuals on the hunt may race each other on certain missions to see who can complete them first.

Such players in the timed challenges, may not even be in the same location, but they can still be “synchronized” and compete against each other in “real time” by virtue of each person having the mobile device app 40 running on his or her smartphone or other mobile device. This optional timed challenge as step 256 is shown in dashed lines off of step 252 relating to receiving the first clue and finding subsequent clues, as such timed challenges can happen at any point and, once completed, the game is simply resumed from there, it being appreciated that one or more such timed challenges may take place basically any time between receipt of the first clue at step 252 and completion of the game/hunt at step 258 and may be before and/or after receipt and redemption of an activity voucher at step 254.

In one embodiment there may be an optional timed challenge at every cluepoint between the start and the finish. The bottom line is that there are a virtually infinite number of possible game scenarios and sequences, such that those skilled in the art will appreciate that the system and method is not limited to any particular game configuration or sequence but instead may take a variety of forms without departing from the spirit and scope of the invention.

In a bit more detail regarding the optional timed challenges, at each cluepoint (post, sign, or gadget) where there is such a challenge, as again dictated and communicated by the app 40, each player has the option of deciding whether or not to take or accept the challenge. The clock that is part of the app 40 starts when the challenge is accepted, at which point all participants in the challenge receive additional directions and clues for the challenge by the app 40.

The clock stops when the code word for the challenge is entered into the app 40, at which point the player's time is posted on the screen and ranked against other players that also took the challenge. Final results of how the participants did will be shown at the end of the game on the app 40.

In one exemplary embodiment, the overall ranking will be based on the number of challenges accepted and the total time, which rankings may be presented against just other participants for that day and/or against all others who have ever completed challenges on the same adventure. It is contemplated that one exemplary embodiment can include a method of conducting an interactive scavenger hunt employing at least one mobile device, the method can include: creating and making available a mobile device app for download to the at least one mobile device; creating and installing one or more custom signs, posts and interactive devices in various locations remote of each other; receiving registration information and a reservation request from a participant via one of a website and the mobile device app; sending an activation code and directions to a participant via the mobile device app; receiving the activation code as provided by a participant via a user interface of a start post at which the interactive scavenger hunt begins; dispensing an adventure kit in response to the provision of the activation code by the participant; providing a first clue to the participant based on one of the mobile device app and the one or more custom signs, posts and interactive devices; and providing subsequent clues via one of the mobile device app and the one or more custom signs, posts and interactive devices based on entry by a participant into the mobile device app of a code acquired through a previous clue. Again, those skilled in the art will appreciate that the features and aspects of the present invention can vary without departing from its spirit and scope.

To summarize, regarding the exemplary embodiments of the present invention as shown and described herein, it will be appreciated that a system and method is disclosed and configured for conducting interactive scavenger hunt games. Because the principles of the invention may be practiced in a number of configurations beyond those shown and described, it is to be understood that the invention is not in any way limited by the exemplary embodiments and is able to take numerous forms without departing from the spirit and scope of the invention.

It will also be appreciated by those skilled in the art that the present invention is not limited to the particular geometries and materials of construction disclosed, if any, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A system for conducting an interactive scavenger hunt employing at least one mobile device, the system comprising:
a mobile device app configured to be selectively installed on the mobile device of a participant;
a network host having one or more of a participant management module, a learning module, a social media module, and a support module, the network host being configured to communicate with the mobile device app over a network; and
at least one interactive device positioned remote of the network host and configured for interaction by a participant during the scavenger hunt based on a clue or configured to receive a clue as directed by the mobile device app.

2. The system of claim 1 wherein the participation management module comprises one or more of an activation code, directions, and clues.

3. The system of claim 1 wherein the learning module is configured for providing educational functionality and content during the scavenger hunt as supplied by the network host to the mobile device app.

4. The system of claim 1 wherein the social media module is configured to send and receive media content during the scavenger hunt as enabled by communication between the network host and the mobile device app.

5. The system of claim 1 wherein the support module comprises one or more of phone support and digital content support as enabled by communication between the network host and the mobile device app.

6. The system of claim 1 wherein the support module is configured with GPS capability, whereby the physical location of a participant is determined and the support module alerts the participant if the participant has deviated from a defined scavenger hunt route relative to the particular scavenger hunt the participant is on, as enabled by communication between the network host and the mobile device app.

7. The system of claim 1 further comprising a start post remote of the network host and the at least one interactive device, the start post having an interface through which the participant communicates an activation code to commence the scavenger hunt.

8. The system of claim 7 wherein the start post is further configured having a dispenser by which is selectively dispensed an adventure kit upon communication of the activation code to the start post via the interface.

9. The system of claim 1 wherein the interactive device comprises a scanner/reader having a source/receptor configured to wirelessly interface with a wristband worn by the participant, whereby the scanner/reader, upon detection of the presence of the wristband via the source/receptor, triggers one of a clue and entertainment.

10. The system of claim 1 wherein the interactive device comprises a motion detector/player having a sensor configured to detect motion and a motion detector speaker coupled electrically thereto, whereby the motion detector/player upon detection of motion via the sensor may trigger one of a clue and entertainment via the motion detector speaker.

11. The system of claim 1 wherein the interactive device comprises a touchscreen.

12. The system of claim 1 wherein the interactive device comprises a camera.

13. The system of claim 1 wherein the interactive device comprises:
a crank generator;
activation progress lights coupled to the crank generator so as to indicate progress of movement of the crank generator; and
a light display electrically connected to the crank generator so as to display a clue upon sufficient movement of the crank generator as indicated by the activation progress lights.

14. The system of claim 1 wherein the interactive device comprises a display device configured to selectively display a clue.

15. The system of claim 1 wherein the interactive device comprises:
an inlet;
an outlet in a first operational state configured to allow liquid, poured into the inlet, to flow out of the interactive device; and
a message window selectively revealing the code if the outlet is blocked in a second operational state.

16. The system of claim 1 wherein the interactive device comprises one or more holes into which a user may blow as through a provided tubing, thereby causing a clue or entertainment to be audibly or visually produced from within the interactive device.

17. The system of claim 1 wherein the interactive device comprises:
a box gadget having a box door and a box lock configured therein for selectively opening the box door to reveal a box message therebehind;
a key lock configured for selectively containing a key, the key being removable from the key lock upon entry therein of an appropriate combination;
whereby entering the combination in the key lock releases the key that is then used to unlock the box door so as to access the box message.

18. The system of claim 1 wherein the interactive device comprises a dial gadget having a dial gadget slot, a windable dial gadget dial activated upon insertion of a coin in the dial gadget slot, and a dial gadget display through which a clue is obtained upon winding of the dial gadget dial.

19. The system of claim 18 wherein the interactive device further comprises a coin gadget having a coin gadget housing with a coin gadget pivot formed therein, the coin gadget housing being further formed therein with a substantially vertical coin channel intersected by a substantially upwardly curved bead channel having multiple beads running therein, whereby the coin is initially retained within the coin channel by the beads in the bead channel, and further whereby spinning the coin gadget housing about the coin gadget pivot serves to inertially displace the beads substantially outwardly and upwardly within the bead channel so as to allow the coin to fall from the coin channel.

20. The system of claim 1 wherein the interactive device comprises a ring gadget configured with a ring gadget transceiver.

21. The system of claim 1 wherein the interactive device comprises a micro beacon gadget configured with a micro beacon gadget transceiver.

22. The system of claim 1 further comprising a sign positioned remote of the network host and of the interactive device.

23. The system of claim 22 wherein the sign comprises a placard bearing graphical content.

24. The system of claim 22 wherein the sign comprises an object in which may be hidden a clue.

25. A method of conducting an interactive scavenger hunt employing at least one mobile device, the method comprising the steps of:
creating and making available a mobile device app for download to the at least one mobile device;
creating and installing one or more custom signs, posts and interactive devices in various locations remote of each other;
sending an activation code and directions to a participant via the mobile device app; and
providing a first clue to the participant based on one of the mobile device app and the one or more custom signs, posts and interactive devices.

26. The method of claim 25 further comprising the steps of:
receiving registration information and a reservation request from a participant via one of a website and the mobile device app; and
confirming the reservation via one of an email and the mobile device app.

27. The method of claim 25 comprising the further step of receiving the activation code as provided by a participant via a user interface of a start post at which the interactive scavenger hunt begins.

28. The method of claim 27 comprising the further step of dispensing an adventure kit in response to the provision of the activation code by the participant.

29. The method of claim 25 comprising the further step of activating a wristband of the participant.

30. The method of claim 25 comprising the further step of providing subsequent clues via one of the mobile device app and the one or more custom signs, posts and interactive devices based on entry by a participant into the mobile device app of a code acquired through a previous clue.

31. The method of claim 25 comprising the further step of providing a voucher via one of the mobile device app and the one or more custom signs, posts and interactive devices.

32. The method of claim 25 comprising the further step of providing an optional timed challenge during the interactive scavenger hunt via the mobile device app.

33. A method comprising:
providing an adventure kit contained within a start post;
limiting access to the adventure kit by requiring a participant to unlock the start post with a code delivered to the participant on a mobile device;
providing an interactive device; and
wherein the adventure kit contains an item that the participant must use to interact with the interactive device.

34. The method of claim 33 wherein providing the adventure kit includes providing the adventure kit containing a first clue intended to be entered into the mobile device.

35. The method of claim 33 wherein providing the adventure kit includes providing the adventure kit containing a necklace, bracelet, ring, gadget, armband, or a combination there of and used to identify the participant with the interactive device.

36. The method of claim 33 wherein the item is a puzzle solving item required to complete a scavenger hunt.

37. The method of claim 36 wherein the puzzle solving item is a water bag, tubing, or a combination thereof.

38. The method of claim 33 wherein providing the adventure kit includes providing the adventure kit and requiring the participant to take the whole kit without leaving any items.

39. The method of claim 33 wherein limiting access to the adventure kit further comprises limiting access to the adventure kit until an activation button is pressed, or until a dispenser is unlocked or activated.

40. The method of claim 33 further comprising providing a first clue together with the adventure kit.
